(19) United States
(12) Patent Application Publication
(10) Pub. No.: US 2003/0021017 A1
(43) Pub. Date: Jan. 30, 2003

(54) Arrangement for micromanipulation of biological specimens

(75) Inventors: Marcel Johan Eijsackers, Dordrecht (NL); Bernard Kleine, Linden (DE); Katja Peter, Wetzlar (DE); Werner Wittke, Braunfels (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Heidelberg GmbH, Mannheim (DE)

(21) Appl. No.: 10/205,090

(22) Filed: Jul. 25, 2002

(30) Foreign Application Priority Data
Jul. 27, 2001 (DE) DE 101 36 481.4

(51) Int. Cl. G02B 21/00; G02B 21/26

(52) U.S. Cl. 359/368; 359/379; 359/391

(57) ABSTRACT

An arrangement for micromanipulation of biological specimens (16), which comprises a microscope (1, 14) having at least one motor-adjustable microscope functional element and at least one motor-adjustable micromanipulator (7, 13) having an injector (20, 21), is described. According to the present invention, the arrangement has associated with it at least one operating console, (8, 23, 24), which comprises at least one operating element (9, 37, 38, 39) for operating both the at least one motor-adjustable microscope functional element and the at least one motor-adjustable micromanipulator (7, 13). The most important functions of the microscope (7, 13), the microscope stage (4), and the micromanipulator (7, 13) can thus be performed centrally at the operating console (8, 23, 24). The operating elements (9, 37, 38, 39) are mounted ergonomically on the operating console (8, 23, 24) in such a way that the hands of a user of the arrangement can remain on the operating console (8, 23, 24) while working.

### CROSS REFERENCE TO RELATED APPLICATIONS

This application claims priority of the German patent application 101 36 481.4-42 which is incorporated by reference herein.

### FIELD OF THE INVENTION

The invention concerns an arrangement for micromanipulation of biological specimens which comprises a microscope having at least one motor-adjustable microscope functional element and at least one motor-adjustable micromanipulator.

### BACKGROUND OF THE INVENTION

Arrangements of this kind are used to perform microscopic manipulations and injections on living material, for example cell colonies, tissue, organs, cells, cell constituents, or embryos of plants or animals. Micromanipulators having mechanical, hydraulic, piezoelectric, or motorized drive systems are known. They are controlled by means of operating elements. An injector (also referred to as an injection capillary) retained on the micromanipulator allows the injection of desired substances or cell constituents into individual cells. Injectors exist with mechanical, pneumatic, and hydraulic drive systems, which are controlled via operating elements. The microscopes used possess mechanical as well as partially motor-activatable functions, which are controlled with various operating elements.

The arrangements used are therefore characterized by a plurality of separate operating elements, arranged at various locations, for the microscope functions, the micromanipulator, and the injector. The user must therefore frequently switch his or her hands among the various operating elements, which is very fatiguing. Slower execution of the experiment and a lower throughput of experiments also result therefrom.

EP 0 292 899 B1 describes a method for microinjection into cells or for aspiration out of individual cells or whole cells from cell cultures. The apparatus used for the purpose comprises a microscope having a motor-driven X-Y-displaceable microscope stage and a motor-driven vertically adjustable micromanipulator for retaining an injection capillary. A computer, an associated monitor, and a graphics tablet are used for motorized control of the microscope position and the vertical position of the micromanipulator. The X-Y position of the micromanipulator is set by means of two setting knobs directly on the micromanipulator, i.e. on the microscope.

The apparatus described here once again requires from the user a continual change of grip and reorientation between the computer, monitor, graphics tablet, and setting knobs in order to set the X-Y position of the micromanipulator. This again results in user fatigue, and in slower execution of the experiment and a lower throughput of experiments.

### SUMMARY OF THE INVENTION

It is therefore the object of the present invention to describe an arrangement for micromanipulation of biological specimens that allows ergonomic operation and increases the achievable throughput of experiments.

The object is achieved by means of an arrangement for micromanipulation of biological specimens that comprises a microscope having at least one motor-adjustable microscope functional element and at least one motor-adjustable micromanipulator having an injector, which is distinguished in that at least one common operating console is associated with the microscope and the at least one micromanipulator. The operating console comprises at least one operating element for operating both the at least one motor-adjustable microscope functional element and the at least one motor-adjustable micromanipulator.

Both an inverted and an upright microscope, having an incident-light arrangement or a transmitted-light arrangement, can be used as the microscope. For the examination of biological specimens, it is usual to work with a transmitted-light arrangement. The motor-adjustable microscope functional element can be, for example:

a microscope stage that is X-Y displaceable or rotatable in motorized fashion;

a vertically motor-displaceable Z drive;

a motor-displaceable objective changing apparatus;

a motor-adjustable fluorescence filter changing device;

a motor-adjustable transmitted-light filter changing device;

a motorized video output control system;

a motor-adjustable condenser;

a motorized light control system; or

a motorized tube lens changing device.

Operation of combinations of several of the aforesaid microscope functional elements is of course possible. From the common operating console, both any desired microscope functional element and the micromanipulator or micromanipulators can be operated by means of associated operating elements. The arrangement according to the present invention can comprise one, two, or more micromanipulators.

Networking of the centrally addressable motor-adjustable microscope functional elements and the at least one motor-adjustable micromanipulator can be accomplished by means of the operating console itself. A corresponding control unit is integrated into the operating console for that purpose. This has the disadvantage, however, that the control unit requires considerable installation space and the operating console thus becomes very large. The heat evolution is also not inconsiderable, which is not always perceived as pleasant by the user. It is also conceivable to incorporate the control unit into the microscope itself. This is unfavorable because of the heat evolution of the control unit, however, since the biological specimens to be manipulated must be protected from excessive temperatures because they are usually living cells or cell cultures.

In an advantageous embodiment, therefore, a separate electronic control unit is provided which networks the at least one motor-adjustable microscope functional element, the at least one motor-adjustable micromanipulator, and the at least one operating console. For that purpose, the control unit is connected to the microscope, the micromanipulator, and the operating console. The control unit can be positioned anywhere.

In an advantageous embodiment, the common operating console comprises at least one memory operating element having an associated memory for storage and retrieval of at least one predefined focal plane. This makes it possible to return quickly to the focal position for routine operations. For example, if several objectives having different linear magnifications or different working distances are used, the different focal planes can be stored and retrieved at the common operating console via the pertinent operating element. Upon retrieval of the focal position for a previously determined objective, the vertically displaceable Z drive of the microscope stage or of the objective is then motor-displaced until the stored focal plane is reached.

In addition, multiple focal planes can be stored for each objective, and arrived at after actuation of an associated operating element. This is used, for example, in the examination of cells, in order to arrive selectably at the surface or the cell nucleus or the underside of the cell. A further focal plane can be placed at the tip of the micromanipulator so that after actuation of the associated operating element, the quality (e.g. sharpness, shape, etc.) of the tip can be checked at any time.

In an advantageous embodiment of the arrangement according to the present invention, an individual value for the, focusing increment can be stored for each objective. This focusing increment indicates the increment (e.g. of a stepping motor) used for motion in the Z direction during focusing. For high-magnification objectives that are characterized by a short focusing travel and shallow depth of field, a small focusing increment is therefore necessary. For low-magnification objectives, which are characterized by a long focusing travel and a large depth of field, a large focusing increment is therefore possible or necessary. When a specific objective is pivoted in (after actuation of the objective changing apparatus), the focusing increment is then automatically set to the previously stored value, so that individually fast or slow focusing with a correspondingly large or small increment can be performed with each objective.

A brightness value can additionally be stored for each objective, a low brightness value typically being preselected for low-magnification (large-aperture) objectives, and a high brightness value for high-magnification (small-aperture) objectives. When a specific objective is pivoted in (after actuation of the objective changing apparatus), the brightness of the illuminating light is then automatically regulated to the previously stored brightness value.

In a further advantageous embodiment of the arrangement, a preselection of frequently required positions is possible for the micromanipulator as well. For that purpose, the at least one common operating console comprises at least one memory operating element having an associated memory that is used for storage and retrieval of at least one predefined position setting of the motor-adjustable micromanipulator or micromanipulators. The preselected and stored positions are usually positions in the context of routine utilization of the microcapillary, for example the position of the capillary tip for perforation of the cell membrane or the position for injecting specific objects into the cell nucleus.

The motor-adjustable microscope functional element can furthermore be embodied as a motor-adjustable filter changing device having various filters. The filters can, for example, serve to set one of several contrast methods. There can also be several fluorescence filters for setting one of several fluorescence methods.

For fluorescence examinations, motor-adjustable neutral density filters or shutters can additionally be provided in the illumination beam path. These allow the illumination beam path to be damped in intensity or completely shut off, in order to protect the biological specimens that are to be observed and manipulated from unintentional heating or bleaching (for example, during work breaks).

In another variant of the filter changing device, multiple color filters and/or damping filters are provided in order to set the spectrum or the brightness of the microscope's illuminating and/or image light.

In an advantageous embodiment, a video output or several video outputs is/are provided on the microscope. A camera adapter, and a camera thereon, can be placed on each video output. The microscope image is then transferred to the camera and displayed on a monitor. In an advantageous embodiment, the arrangement according to the present invention has as the motor-adjustable microscope functional element a motorized video output control system that deflects the image light entirely or partially to one or more video outputs. The partial deflection can be accomplished by means of motor-displaceable prisms or filters or beam splitters, in the form of an intensity split or in the form of a color split (i.e. by the selection of specific wavelength regions).

Further motorized microscope functional elements that can be activated via the common operating console for the microscope and the micromanipulator are, for example, a motor-adjustable condenser and a motorized light control system. The motor-adjustable condenser serves to change components arranged in the condenser, e.g. to change phase rings or to change Wollaston prisms that are required for the differential interference contrast (DIC) method. The motorized light control system provides brightness control in the beam path, e.g. by introducing and removing filters and shutters.

It is of course also possible to control combinations of the aforesaid motor-adjustable microscope functional elements and the motor-adjustable micromanipulator (or several micromanipulators) from the common operating console.

In an advantageous embodiment, at least one memory operating element having an associated memory, which is provided for the storage and retrieval of at least one predefined setting of at least one of the motor-adjustable microscope functional elements, is provided on the operating console.

The operating console can be arranged on the microscope or also integrated into the microscope housing. It has proven to be particularly advantageous if the operating console is arranged separately from the microscope, since the position of the operating console, e.g. on the laboratory bench, can then be selected by the user him- or herself in accordance with his or her individual ergonomics.

If two or more micromanipulators are arranged on the microscope, a single operating console can be provided that has at least one operating element in each case for at least one of the micromanipulators. This depends on which functions are available in motorized fashion on the micromanipulator.

If, in particular, exactly two micromanipulators are arranged on the microscope, a single operating console that comprises two separate operating elements for the respective X-Y adjustment and/or the vertical adjustment of the two micromanipulators can be arranged. An embodiment in which these two operating elements are each associated with one of the user's hands proves to be particularly user-friendly. This hand-specific association proves to be very user-friendly because it is familiar to microscope users, e.g. from manual adjustment of the microscope stage.

If two or more micromanipulators are arranged on the microscope, two common operating consoles can be provided, each of which comprises at least one operating element for at least one of the micromanipulators and at least one motor-adjustable microscope functional element. With the use of two operating consoles, for example, the operating elements that are associated either with specific functions or with specific microscope functional elements or micromanipulators can be grouped on the one or the other operating console. This considerably simplifies operational training of the user.

In order to expand the utilization of the arrangement, the arrangement has associated with it a UV laser whose laser beam is coupled into the microscope with a coupling-in optical system. This coupled-in laser beam is focused with an objective onto a biological specimen for laser cutting of the biological specimen. The functionality of the arrangement is thus considerably improved as a supplement to the micromanipulators and injectors, since prior or subsequent preparation by means of laser microdissection of the biological specimens to be manipulated is thereby possible. In addition, the arrangement can have associated with it an IR laser whose laser beam is coupled into the microscope with a coupling-in optical system and is focused with an objective onto the biological specimen. The focused IR laser beam is used to intercept, hold, and move the biological specimen. In order to control the UV laser and/or IR laser, at least one operating element for controlling the laser functions (e.g. on/off or focus/defocus) is arranged on the (at least one) operating console.

The essential element of the arrangement according to the present invention is a centrally arranged operating console, working in common fashion for the microscope and the micromanipulator or micromanipulators, with which the most important functions of the microscope, the microscope stage, and the micromanipulator can be performed centrally. The operating elements are mounted on the operating console in such a way that the user's hands can remain on the operating console while working, and all the functions can be reached conveniently. An ergonomic and user-friendly configuration of the operating console prevents hand and wrist fatigue.

### BRIEF DESCRIPTION OF THE DRAWINGS

The invention will be explained in more detail below with reference to the schematic drawings, in which:

FIG. 1 shows an arrangement for micromanipulation of biological specimens having an inverted microscope, a micromanipulator, and a common operating console;

FIG. 2 shows an arrangement for micromanipulation of biological specimens having an inverted microscope, two micromanipulators, and a common operating console;

FIG. 3 shows an arrangement for micromanipulation of biological specimens having an upright microscope, two micromanipulators, and two common operating consoles;

FIG. 4 shows an arrangement for micromanipulation of biological specimens having an upright microscope with a coupled-in laser beam, two micromanipulators, and two common operating consoles;

FIG. 5 shows an arrangement for micromanipulation of biological specimens having an inverted microscope, two micromanipulators, and two common operating consoles.

### DETAILED DESCRIPTION OF THE INVENTION

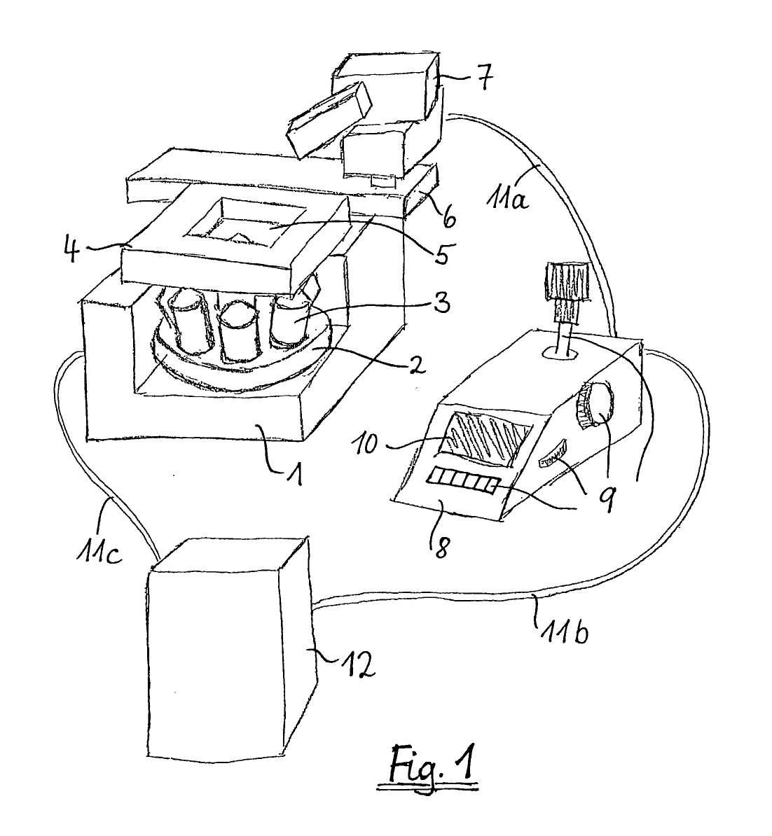

FIG. 1 shows an arrangement for micromanipulation of biological specimens that is based on an inverted microscope 1. Microscope 1 is depicted in highly schematic fashion in order to make the depiction clear. An objective changing apparatus 2 having multiple objectives 3 is arranged on microscope 1. A motorized microscope stage 4 for the reception of biological specimens (not depicted here) is arranged above objectives 3 on inverted microscope 1. Microscope stage 4 has an internally located opening 5 through which the biological specimens can be illuminated and viewed in transmitted light. An illumination beam path with a condenser (both not shown) is arranged for that purpose above microscope stage 4. An adapter 6 that is provided for the attachment of micromanipulators is mounted on microscope 1. A motorized micromanipulator 7 is arranged on said adapter 6. The drive systems for moving micromanipulator 7 in the three spatial directions X, Y, and Z are not depicted for simplicity's sake.

A common operating console 8 is provided for microscope 1 and micromanipulator 7. Operating console 8 comprises multiple operating elements 9 for operation of the motor-adjustable microscope functional elements and of the motorized micromanipulator 7. The term “motor-adjustable microscope functional element” is to be understood as a comprehensive general designation for all functional elements on the microscope that are adjustable in motorized fashion. In the example depicted, these can be both objective changing apparatus 2 and the motorized microscope stage 4. Operating elements 9 can each be associated with specific microscope functional elements or specific functions of micromanipulator 7. It is also conceivable, however, to associate one operating element 9 with several functional elements or micromanipulator functions, in which context the particular function desired can be activated. In the present example, operating console 8 additionally comprises a display element 10 (e.g. an LCD display) with which the aforementioned microscope functional elements, or the settings made on inverted microscope 1 or micromanipulator 7, can be displayed.

Operating console 8 is connected with a control line 11a to motorized micromanipulator 7 and with a control line 11b to a separately arranged control unit 12. This control unit 12 is in turn connected with a control line 11c to the motorized microscope functional elements in microscope 1. This control unit 12 serves to network the motor-adjustable microscope functional elements, motor-adjustable micromanipulator 7, and common operating console 8. It is also possible, of course, to integrate control unit 12 either into operating console 8 or into inverted microscope 1. Since considerable heat is evolved by control unit 12, however, control unit 12 was arranged separately in the embodiment of the arrangement for manipulation of biological specimens depicted here. It appears in FIG. 1 as if said control unit 12 is standing on the same laboratory bench as microscope 1 and operating console 8. Such a depiction is only for reasons of clarity, however. In reality, control unit 12 is set up as far away as possible from microscope 1, for example under the laboratory bench. Operating console 8 is then also easily and ergonomically accessible to a user of the arrangement according to the present invention.

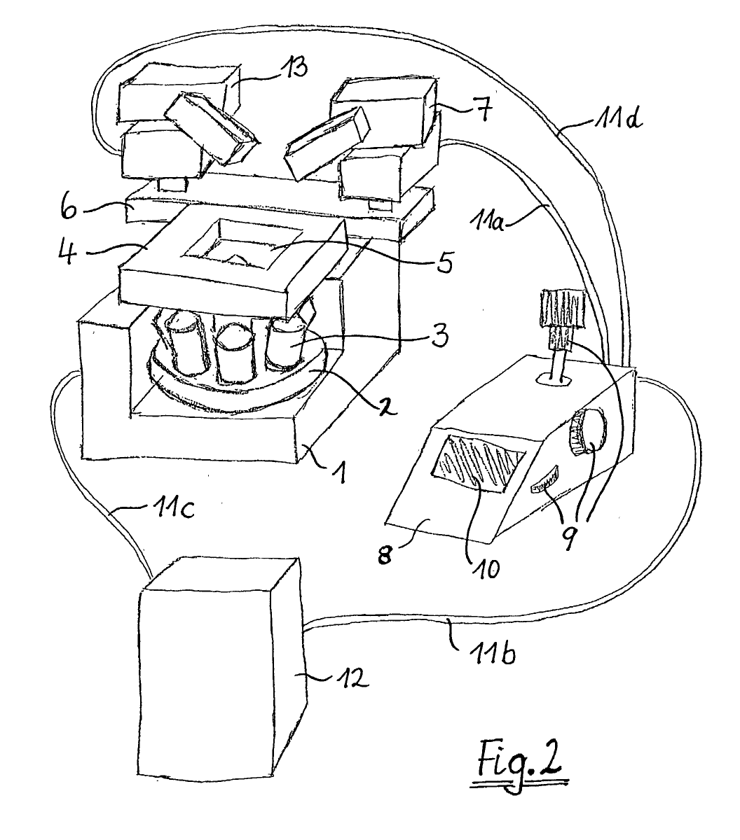

FIG. 2 shows an arrangement for micromanipulation of biological specimens that is equipped, in contrast to the depiction in FIG. 1, with a second micromanipulator.

An inverted microscope 1 comprises an objective changing apparatus 2 having multiple objectives 3 attached thereto and a motorized microscope stage 4. An illumination beam path with a condenser, arranged above microscope stage 4, was not depicted here for the sake of clarity in the depiction.

An adapter 6 that serves for the attachment of micromanipulators is mounted on microscope 1. A first motorized micromanipulator 7 and a second motorized micromanipulator 13 are attached on said adapter 6. The two micromanipulators 7, 13 can be moved in the three spatial directions X, Y, and Z. They serve to receive injectors (not depicted here) with which biological specimens can be manipulated. The type of manipulation can encompass the injection or aspiration of liquids or cell components, or similar interventions.

A common operating console 8 is associated with microscope 1 with its motorized microscope functional elements (in this case, motorized objective changing apparatus 2 and motorized microscope stage 4) and with the two micromanipulators 7 and 13. Said operating console 8 is connected with a control line 11a to first motorized micromanipulator 7 and by means of a control line 11d to second motorized micromanipulator 13.

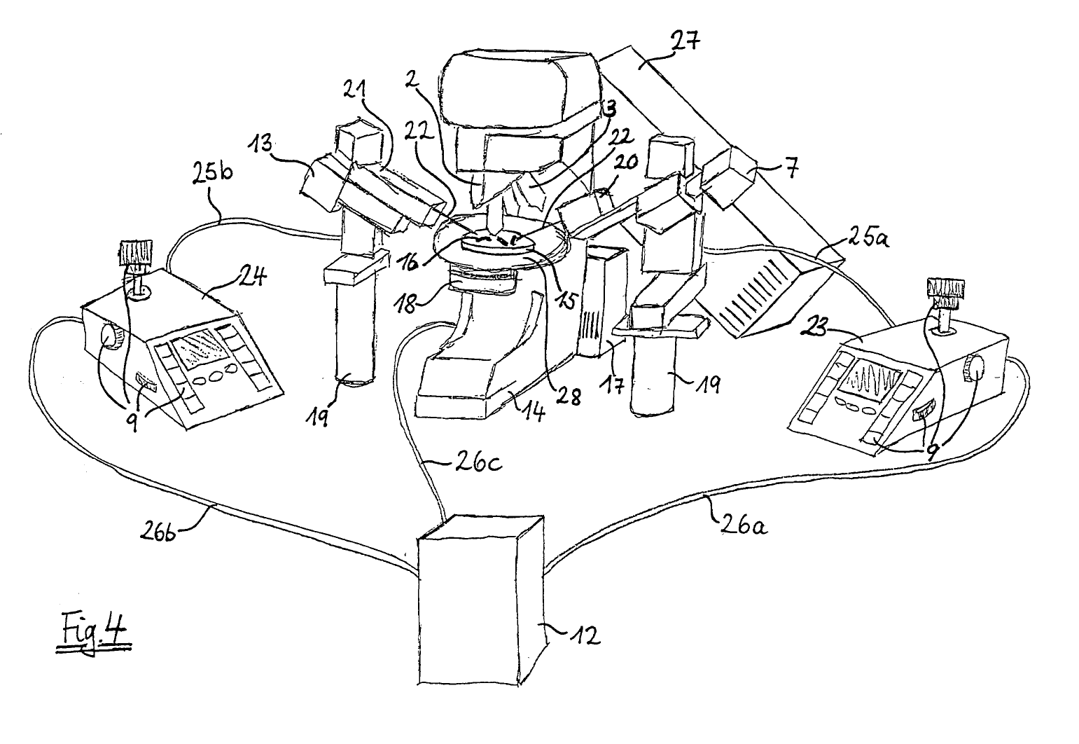

A control unit 12, which is connected with a control line 11b to operating console 8 and with a control line 11c to microscope 1, i.e. to the motorized microscope functional elements, is associated with the arrangement. Control unit 12 networks the functional elements of microscope 1 addressed from operating console 8 and the controlled micromanipulators 7, 13. Memories (data memories or image memories) for the storage of specific data necessary for the operation of the microscope functional elements or micromanipulators 7, 13 are provided in control unit 12 or in operating console 8. Operating console 8 comprises multiple operating elements 9 that are associated with the various motor-driven functional elements of microscope 1 and/or with the two micromanipulators 7, 13 (or even with only one of them). Details regarding the operating elements are described with reference to FIG. 4. The manner in which microscope 1, micromanipulators 7, 13, operating console 8, and control 12 are networked can also be different from what is depicted here. The type of networking depends, for example, on the interfaces or data transfer protocols that are used.

Control unit 12 can also be integrated into microscope 1 or into operating console 8. In order to protect microscope 1 from undesirable heat evolution, however, a separate placement of control unit 12 was preferred in the arrangement depicted here.

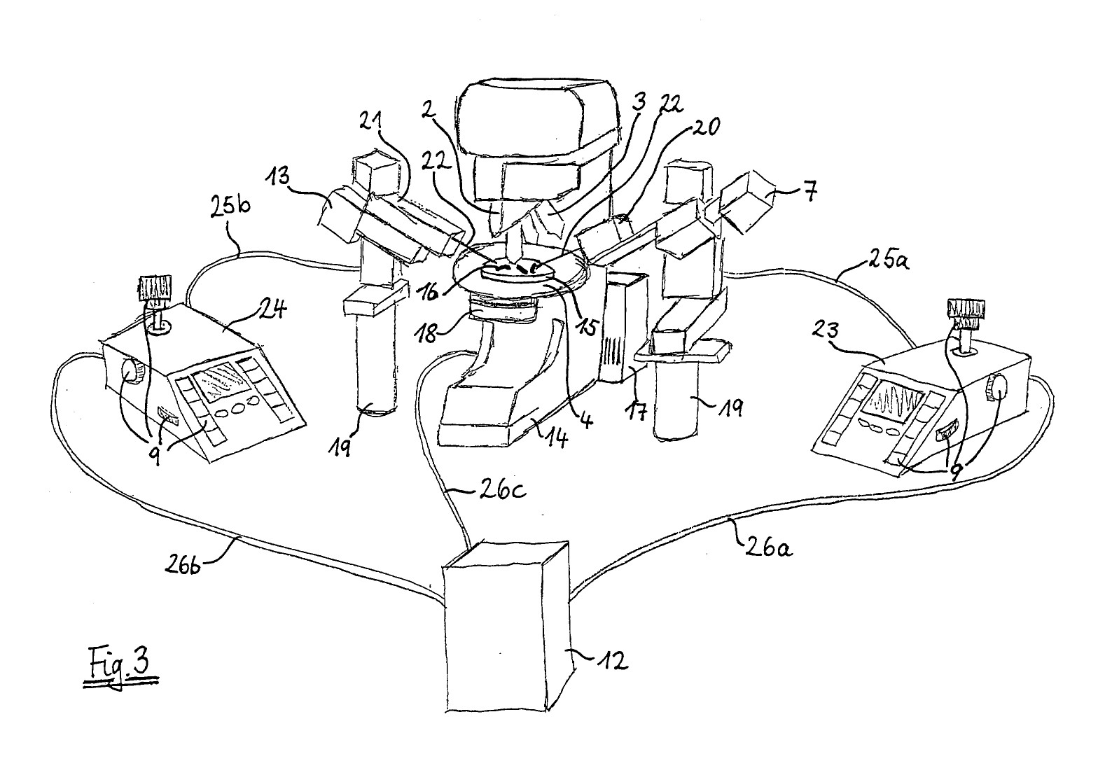

FIG. 3 shows an arrangement according to the present invention for micromanipulation of biological specimens in which two operating consoles are provided for a microscope having two associated micromanipulators.

An upright microscope 14 comprises a motorized objective changing apparatus 2 having multiple objectives 3 arranged thereon. A motorized microscope stage 4 (drive systems not depicted) serves to receive a vessel 15 with biological specimens 16 present thereon. An illumination beam path (not depicted here), which is directed through a condenser 18 onto biological specimens 16, proceeds from a lamp housing 17 arranged on microscope 14.

A first motorized micromanipulator 7 and a second motorized micromanipulator 13 are provided for manipulation of biological specimens 16. In the example depicted here, they are attached separately from the microscope on support elements 19 that are not joined to the microscope. It is also conceivable, however, to join the micromanipulators to the microscope in the manner already depicted in FIGS. 1 and 2, i.e. by means of an adapter directly on the microscope.

A first injector 20 is arranged on first motorized micromanipulator 7, and a second injector 21 on second motorized micromanipulator 13. For simplification, the necessary pressure control devices for controlling the pressure in injectors 20, 21 (e.g. for injecting or extracting liquids or cell constituents) are not depicted. The manipulations on the biological specimens are performed with microcapillaries 22 that are connected to injectors 20, 21. For the performance of precise operations on biological specimens 16 (e.g. injecting liquids or cell material), the tips of the particular microcapillaries 22 being activated must be precisely positioned.

The arrangement comprises a first operating console 23 and a second operating console 24. First operating console 23 is connected with a control line 25a to first micromanipulator 7. Second operating console 24 is connected with a control line 25b to second micromanipulator 13. For networking of microscope 14, micromanipulators 7 and 13, and the two operating consoles 23 and 24, the arrangement comprises a control unit 12 which networks these components of the arrangement. For that purpose, control unit 12 is connected with a control line 26a to first operating console 23, with a control line 26b to second operating console 24, and with a control line 26c to microscope 14 or to the motorized motor-adjustable microscope functional elements.

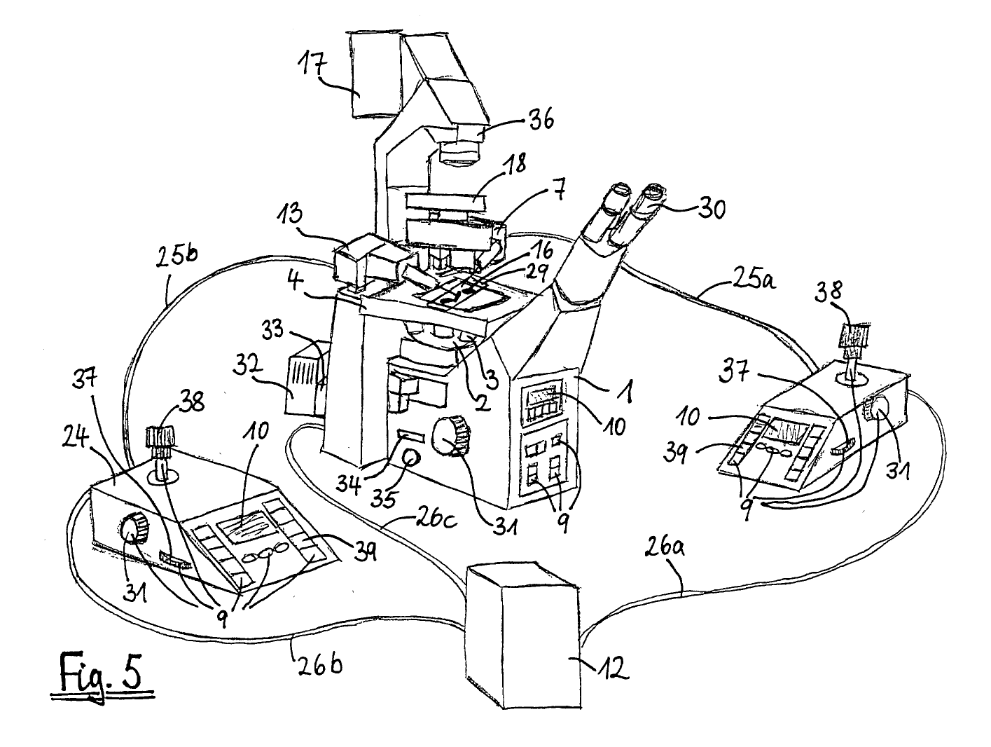

Control unit 12 is designed in such a way that operation of microscope 14 or of its motorized microscope functional elements (in this case, motorized microscope stage 4 and motorized objective changing apparatus 2) and of the two micromanipulators 7 and 13 can be accomplished alternatively both from first operating console 23 and from second operating console 24. For that purpose, the two operating consoles 23, 24 comprise a number of operating elements 9 that are or can be associated with the various motorized functions on microscope 14 or with micromanipulators 7, 13. Details of operating elements 9 are described with reference to FIG. 5.

Control unit 12 can be integrated into microscope 14 or into one or both of operating consoles 23, 24. But because control unit 12, which contains the electronics, evolves a considerable amount of heat, in the arrangement depicted here control unit 12 was set up separately. This prevents unnecessary heating of biological elements 16. A further advantage of the separate arrangement of control unit 12 is the fact that microscope 14, with micromanipulators 7, 13 arranged next to it, can be introduced into a small climate-controlled chamber (not depicted here) of limited size, while control unit 12 is arranged outside the climate-controlled chamber.

FIG. 4 shows a variant of the arrangement already described in FIG. 3. The arrangement comprises an upright microscope having a microscope stage 28 to be actuated manually, an objective changing apparatus 2 with multiple objectives 3 mounted thereon, and a first micromanipulator 7 as well as a second micromanipulator 13. The microscope functional elements and micromanipulators 7 and 13 are operated by way of a first common operating console 23 and a second common operating console 24. Networking of the arrangement is accomplished with a control unit 12. The latter is connected with a first control line 26a to first operating console 23, with a control line 26b to second operating console 24, and with a control line 26c to microscope 14 and thus to its microscope functional elements.

Transmitted-light illumination of biological specimens 16 in vessel 15 is accomplished with an illumination beam path that proceeds from a lamp housing 17 and is directed through a condenser 18 onto the biological specimens.

As an addition to the arrangement shown in FIG. 3, the embodiment of the arrangement according to the present invention depicted here comprises an additional light source. It is a laser 27 whose laser beam is coupled into an incident-light beam path (not depicted here) in the upper region of microscope 14, and is focused with one of objectives 3 onto the biological specimens.

The laser can be either a UV laser or an IR laser. If the biological specimens are to be processed by laser microdissection, a UV laser is used. The UV laser beam is then used in the focused state for dissection on the biological specimens. An IR laser, whose laser beam can again be focused with an objective 3 onto a biological specimen 16, can alternatively be used. Biological specimen 16 (or portions thereof) that is intercepted by the focus of the IR laser beam is pulled into that laser focus and can then be held by moving the laser focus, and moved along with it. This principle is often also referred to as “optical tweezers.” In order to control the UV laser and/or IR laser, an operating element 9 that serves to control the laser functions is arranged on at least one of operating consoles 23, 24. The laser functions can be: switching on or off or controlling the pulse rate (for pulsed lasers), or focusing/defocusing at the location of the biological specimens, or increasing/decreasing the intensity.

Operating consoles 23 and 24 can comprise different operating elements 9. It has proven advantageous, however, if the two operating consoles 23, 24 are identically configured, so that all the functions that can be addressed by means of operating elements 9 can be addressed with both the left and the right hand of the person using the arrangement.

FIG. 5 shows an arrangement according to the present invention having an inverted microscope 1 that comprises a motorized microscope stage 4. A transmitted-light illumination beam path (not depicted here) proceeding from a lamp housing 17 is directed through a condenser 18, which in this case is of motorized configuration, onto biological specimens 16 that are arranged on a specimen holder 29. Beneath the frame-shaped microscope stage 4, several objectives 3 are arranged on an objective changing apparatus 2. Visual observation of the microscope image of biological specimens 16 can be accomplished through eyepieces 30. A first micromanipulator 7 and a second micromanipulator 13 are arranged on microscope 1.

The arrangement comprises two operating consoles 23 and 24 for operation of the microscope functional elements and the two micromanipulators 7, 13. Operating console 23 is connected with a control line 25a to micromanipulator 7, and operating console 24 is connected with a control line 25b to micromanipulator 13. A control unit 12 for networking operating consoles 23, 24, microscope 1 with its microscope functional elements, and the two micromanipulators 7, 13 is associated with the arrangement. Control unit 12 is connected with a control line 26a to operating console 23, with a control line 26b to operating console 24, and with a control line 26c to microscope 1. Multiple operating elements 9, which permit operation of the microscope functional elements and the two micromanipulators 7 and 13, are arranged on operating consoles 23 and 24.

In the particularly advantageous embodiment depicted here, microscope 1 also comprises operating elements 9 for actuation of its microscope functional elements. It is thus possible to effect operation of specific functions both from one of operating consoles 23 or 24 and from microscope 1 itself. For example, both operating console 23 and operating console 24, as well as microscope 1, comprise a Z drive knob 31 for focusing the microscope. The technical implementation of the focusing function can consist in vertical adjustment of microscope stage 4 or in vertical adjustment of objectives 3 or objective changing apparatus 2.

Some of the microscope functional elements that can be embodied in motorized fashion will be explained in more detail below. Microscope 1 is equipped, in addition to transmitted-light lamp housing 17, with a fluorescent lamp housing 32. A motorized fluorescence filter slider 33 is arranged in the fluorescence beam path (not depicted) proceeding from this fluorescence lamp housing 32. A tube lens changing apparatus 34 having multiple tube lenses mounted thereon is arranged in the image beam path (not depicted here). Since the tube lenses, together with objectives 3, represent a compensation system relating to image correction of the microscope image, the correct tube lens must be associated with each objective 3. By means of the motorized tube lens changing apparatus 34, it is possible for the user to perform this appropriate association conveniently at any time.

Also mounted in the image beam path are multiple video outputs 35, of which only one is depicted here by way of example. On these video outputs 35 is placed a camera adapter, and on the latter a camera (not depicted). The microscope image is then transferred to the camera and can be displayed on a monitor. In order to deflect the image light of the image beam path entirely or partially to one or more of said video outputs 35, a motorized video output control system (not depicted here) is provided in the lower part of microscope 1. Partial deflection of the image light can be performed by means of motor-movable prisms or filters or beam splitters, in such a way that either an intensity split of the image light or a color split (i.e. by selection of specific wavelength regions) can be effected. Operation of said video output control system can be effected by way of a respectively associated operating element 9 both on operating console 23 and on operating console 24.

As a further motorized microscope functional element, microscope 1 comprises a motorized transmitted-light filter changing apparatus 36. It permits motorized introduction or removal of color filters, neutral density filters, etc. into or from the transmitted-light beam path. Operation is accomplished by way of an associated operating element 9 on operating console 23 and/or operating console 24.

Operating consoles 23 and 24 can be differently configured, but advantageously comprise the same functional elements. For example, they each comprise a display element 10 which can be embodied, for example, as a simple LCD display but can also be embodied as an interactive display with touch surfaces. In the embodiment depicted here, operating consoles 23 and 24 furthermore comprise an operating wheel 37 that can be used, for example, for brightness control or for stepwise adjustment when focusing objectives or for actuation of the Z motion of micromanipulators 7 and 13. An operating lever 38, which is movable in the manner of a joystick, can be selectably used to control the X-Y motion of microscope stage 4 or the X-Y motion of micromanipulators 7 and/or 13.

In the examples described, both operating wheel 37 and operating lever 38 have a double assignment or even multiple assignment of functions. Activation of the desired function can be accomplished, for example, by operating one or more of buttons 39. Others of said buttons 39 can be used, for example, to actuate motorized objective changing apparatus 2 or to select or control specific manipulator operating states. Display element 10 provides the user with orientation when selecting the particular desired operating element. For example, the particular operating state that is activated, e.g. selected capillary tip focus point or selected objective or selected manipulator operating state, can be displayed; in addition, the microscope functional element that is activated on the multiple-assignment operating elements (for example, operating wheel 37 or operating lever 38), or the currently activated function of micromanipulators 7 and 13, can be displayed.

An embodiment of the arrangement according to the present invention in which a so-called priority monitoring of the two operating consoles 23 and 24 is performed by means of control unit 12 has proven particularly advantageous. In this context, control unit 12 recognizes, for example, when a specific function, for example on operating console 23, has been applied to operating lever 38. This can be done, for example, by the actuation of buttons, but can also be accomplished by monitoring the startup of operating lever 38. As soon as control unit 12 has recorded the fact that, for example, operating lever 38 has been activated to the function “Displace microscope stage in X or Y direction,” that function is automatically also applied to the corresponding operating lever 38 on the other operating console, i.e. operating console 24. This prevents the user from inadvertently addressing a different function when touching operating lever 38 with his or her left hand, which would access operating console 24. Cancellation of the function assignment of operating lever 38 is then accomplished by the user with a defined function cancellation, for example by pressing a specific one of buttons 39.

The arrangement according to the present invention makes it possible work in a very user-friendly and ergonomic fashion even on a routine basis. By individually configuring the function assignment of the two operating consoles 23 and 24, the user can set up his or her own individual working environment. This allows him or her to work in a relaxed and non-fatiguing manner, which is a necessity in particular for routine operations.

### Parts List

1 Inverted microscope

2 Objective changing apparatus

3 Objectives

4 Microscope stage

5 Internally located opening

6 Adapter

7 First micromanipulator

8 Operating console

9 Operating elements

10 Display element

11 Control lines (11a, b, c)

12 Control unit

13 Second micromanipulator

14 Upright microscope

15 Vessel

16 Biological specimens

17 Lamp housing

18 Condenser

19 Support elements

20 First injector

21 Second injector

22 Microcapillary

23 First operating console

24 Second operating console

25 Control line (25a, b)

26 Control line (26a, b, c)

27 Laser

28 Manual microscope stage

29 Specimen holder

30 Eyepieces

31 Z drive knob

32 Fluorescence lamp housing

33 Fluorescence filter changing apparatus

34 Tube lens changing apparatus

35 Video output

36 Transmitted-light filter changing apparatus

37 Operating wheel

38 Operating lever

39 Buttons

What is claimed is:

1. An arrangement for micromanipulation of biological specimens (16) comprising:
a microscope (1, 14) having at least one motor-adjustable microscope functional element, at least one motor-adjustable micromanipulator (7, 13) having an injector (20, 21),
at least one common operating console, (8, 23, 24), which comprises at least one operating element (9, 37, 38, 39) for operating both said at least one motor-adjustable microscope functional element and said at least one motor-adjustable micromanipulator (7, 13),
connecting means which connect said operating console to said microscope (1, 14) and said at least one micromanipulator (7, 13).

2. The arrangement as defined in claim 1, wherein an electronic control unit (12) is provided which networks said at least one motor-adjustable microscope functional element, said at least one motor-adjustable micromanipulator (7, 13), and said at least one operating console (8, 23, 24).

3. The arrangement as defined in claim 1, wherein said motor-adjustable microscope functional element is a microscope stage (4) that is X-Y displaceable or rotatable in motorized fashion.

4. The arrangement as defined in claim 1, wherein said motor-adjustable microscope functional element is a vertically motor-displaceable Z drive for moving a microscope stage (4) or an objective (3) of said microscope for setting the focal plane.

5. The arrangement as defined in claim 4, wherein operating console (8, 23, 24) comprises at least one memory operating element (9) having an associated memory for storage and retrieval of at least one selected focal plane.

6. The arrangement as defined in claim 1, wherein said at least one operating console (8, 23, 24) comprises at least one memory operating element having an associated memory for storage and retrieval of at least one predefined setting of said at least one motor-adjustable micromanipulator (7, 13).

7. The arrangement as defined in claim 1, wherein said motor-adjustable microscope functional element is embodied as
a motor-displaceable objective changing apparatus (2) having multiple objectives (3) for selectable introduction of one of the objectives (3) into an illumination beam path of said microscope.

8. The arrangement as defined in claim 1, wherein said motor-adjustable microscope functional element is embodied as
a motor-adjustable filter changing device (33, 36) having various filters.

9. The arrangement as defined in claim 1, wherein said motor-adjustable microscope functional element is embodied as
a motorized video output control system.

10. The arrangement as defined in claim 8, wherein said filter changing device comprises several filters for setting one of several contrast methods.

11. The arrangement as defined in claim 8, wherein said the filter changing device (33) comprises several fluorescence filters for setting one of several fluorescence methods.

12. The arrangement as defined in claim 8, wherein said filter changing device comprises several color filters and damping filters for setting the spectrum or the brightness of the illuminating light and/or image light of the microscope (1, 14).

13. The arrangement as defined in claim 8, wherein said filter changing device comprises several color filters or damping filters for setting the spectrum or the brightness of the illuminating light and/or image light of the microscope (1, 14).

14. The arrangement as defined in claim 1, wherein the at least one operating console (8, 23, 24) is provided for the operation of a combination of one or more of the following motor-adjustable microscope functional elements:
a microscope stage (4) that is X-Y displaceable or rotatable in motorized fashion;
a vertically motor-displaceable Z drive;
a motor-displaceable objective changing apparatus (2);
a motor-adjustable fluorescence filter changing device (33);
a motor-adjustable transmitted-light filter changing device (36);
a motorized video output control system;
a motor-adjustable condenser (18);
a motorized light control system; or
a motorized tube lens changing device (34), and the motor-adjustable micromanipulator (7, 13).

15. The arrangement as defined in claim 1, wherein said at least one operating console (8, 23, 24) comprises at least one memory operating element having an associated memory for storage and retrieval of at least one predefined setting of at least one of the motor-adjustable microscope functional elements.

16. The arrangement as defined in claim 1, wherein said operating console (8, 23, 24) is mounted on the microscope (1, 14).

17. The arrangement as defined in claim 1, wherein said operating console (8, 23, 24) is integrated into the housing of the microscope (1, 14).

18. The arrangement as defined in claim 1, wherein said operating console (8, 23, 24) is arranged separately from the microscope (1, 14).

19. The arrangement as defined in claim 1, wherein two or more micromanipulators (7, 13) are arranged on the microscope (1, 14); and a single operating console (8, 23, 24) is provided that comprises at least one respective operating element (9, 37, 38, 39) for at least one of the micromanipulators (7, 13).

20. The arrangement as defined in claim 19, wherein two micromanipulators (7, 13) are arranged on the microscope (1, 14); and a single operating console (8, 23, 24) is provided that comprises two separate operating elements (9, 37, 38, 39) for the respective X-Y adjustment and/or vertical adjustment of the two micromanipulators (7,13).

21. The arrangement as defined in claim 20, wherein the two operating elements (9, 37, 38, 39) are each associated with one of a user's hands.

22. The arrangement as defined in claim 1, wherein two or more micromanipulators (7,13) are arranged on said microscope (1, 14); and two operating consoles (8, 23, 24) are provided, each of which comprises at least one operating element (9, 37, 38, 39) for at least one of said micromanipulators (7, 13).

23. The arrangement as defined in claim 1, comprising an UV laser (27) whose laser beam is coupled into the microscope (1, 14) with a coupling-in optical system and is focused onto a biological specimen (16) with an objective (3) for laser dissection of the biological specimen (16).

24. The arrangement as defined in claim 1, comprising an IR laser (27) whose laser beam is coupled into the microscope (1, 14) with a coupling-in optical system and is focused with an objective (3) onto the biological specimen (16), and is used to intercept, hold, and move the biological specimen (16) or parts of the biological specimen (16).

25. The arrangement as defined in claim 23, wherein the at least one operating console (8, 23, 34) comprises at least one operating element (9, 37, 38, 39) for controlling at least one function of said UV laser.

26. The arrangement as defined in claim 24, wherein the at least one operating console (8, 23, 34) comprises at least one operating element (9, 37, 38, 39) for controlling at least one function of said IR laser.
